(19) United States
(12) Patent Application Publication
(10) Pub. No.: US 2004/0046929 A1
(43) Pub. Date: Mar. 11, 2004

(54) Integrally formed pair of lenses for a pair of glasses

(75) Inventor: James Wu, Tainan (TW)

Correspondence Address: BACON & THOMAS, PLLC, 625 SLATERS LANE, FOURTH FLOOR, ALEXANDRIA, VA, 22314

(73) Assignee: Foresight Optical Ltd., Tainan (TW)

(21) Appl. No.: 10/236,933

(22) Filed: Sep. 9, 2002

(51) Int. Cl. G02C 5/02; G02C 7/02

(52) U.S. Cl. 351/134

(57) ABSTRACT

An integrally formed pair of lenses has a curved body and a curved bridge formed on the middle portion to divide the body into two lens portions. The bridge has a radius of curvature different from that of the lens portions so a nose pad can be formed without any additional processes being necessary. Accordingly, the appearance of a pair of glasses with the integrally formed pair of lenses is versatile, and the cost of manufacturing the glasses is reduced.

### BACKGROUND OF THE INVENTION

1. Field of the Invention

The present invention relates to a pair of lenses, and more particularly to an integrally formed pair of lenses for a pair of glasses to make the appearance of the glasses versatile.

2. Description of Related Art

Sunglasses and sport glasses not only protect a user's eyes, but also provide a decorative effect to the user. Sunglasses are generally made in two substantially different general styles. One general style has two separate lenses mounted in a spectacles frame. The other general style has two lenses integrally formed as a single lens piece and mounted on a spectacle frame.

With reference to FIGS. 4 to 6, a conventional pair of glasses with integrally formed lenses has a conventional single lens piece (30), a frame (40) and a nose pad (32). The conventional single lens piece (30) has a curved body, and the body is formed into two lens portions with a bridge between the lens portions so single lens piece (30) fits the spectacle frame (40). In addition, a nose pad (32) must be separately attached to the bridge of the conventional single lens piece (30). However, each conventional single lens piece (30) only has a single curvature, so the appearance of the pair of glasses with the conventional single lens piece (30) is dull. Furthermore, attaching the nose pad (32) to the bridge between the lens portions can cause the assembly the pair of glasses with the conventional single lens piece (30) to be troublesome.

To overcome the shortcomings, the present invention provide a lens to mitigate or obviate the aforementioned problems.

### SUMMARY OF THE INVENTION

The main objective of the invention is to provide an integrally formed pair of lenses for a pair of glasses, which has a versatile appearance. The integrally formed pair of lenses has a curved body and a raised bridge formed to divide the body into two lens portions. The bridge has a curvature different from that of the lens portions and can serve as a nose pad without any further assembly steps necessary. Consequently, the appearance of the glasses with the integrally formed pair of lenses in accordance with the invention is versatile, and the cost for manufacturing the glasses is reduced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an integrally formed pair of lenses in accordance with the present invention;

FIG. 2 is a perspective view of the pair of lenses in FIG. 1 after the pair of lenses has been cut to a desired shape;

FIG. 3 is a perspective view of a pair of glasses with the pair of lenses in FIG. 2;

FIG. 4 is a perspective view of a conventional single lens piece with two lenses in accordance with the prior art;

FIG. 5 is a perspective view of the conventional single lens piece in FIG. 4 after the single lens piece has been cut to a shape to be mounted on a frame; and

FIG. 6 is a perspective view of a pair of glasses with the conventional single lens piece in FIG. 5 with a nose pad attached.

### DETAILED DESCRIPTION OF PREFERRED EMBODIMENT

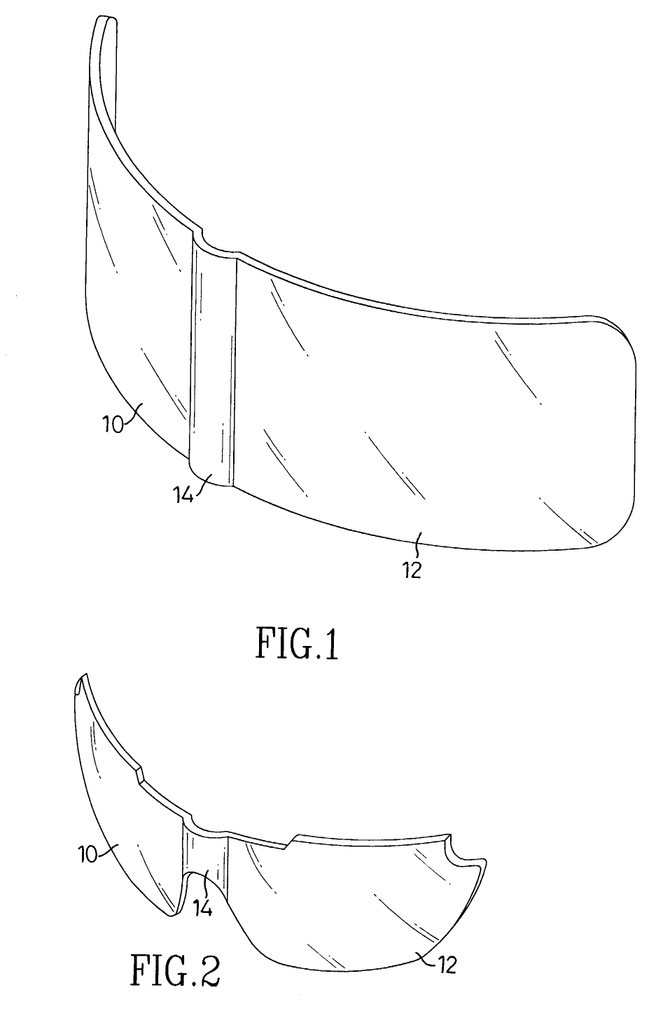

With reference to FIG. 1, an integrally formed pair of lenses in accordance with the present invention comprises a curved body with a middle portion and at least two radii of curvature. A curved bridge (14) with a bottom is formed at the middle portion of the body to divide the body into two lens portions (10, 12). The bridge (14) has a radius of curvature different from that of the lens portions (10, 12) to cause the bridge (14) to be raised from the lens portions (10, 12). The radius of curvature of the lens portions (10, 12) is the same.

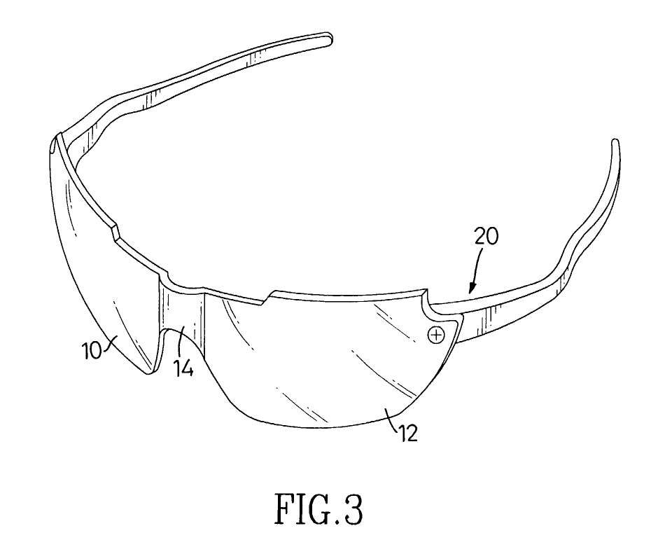

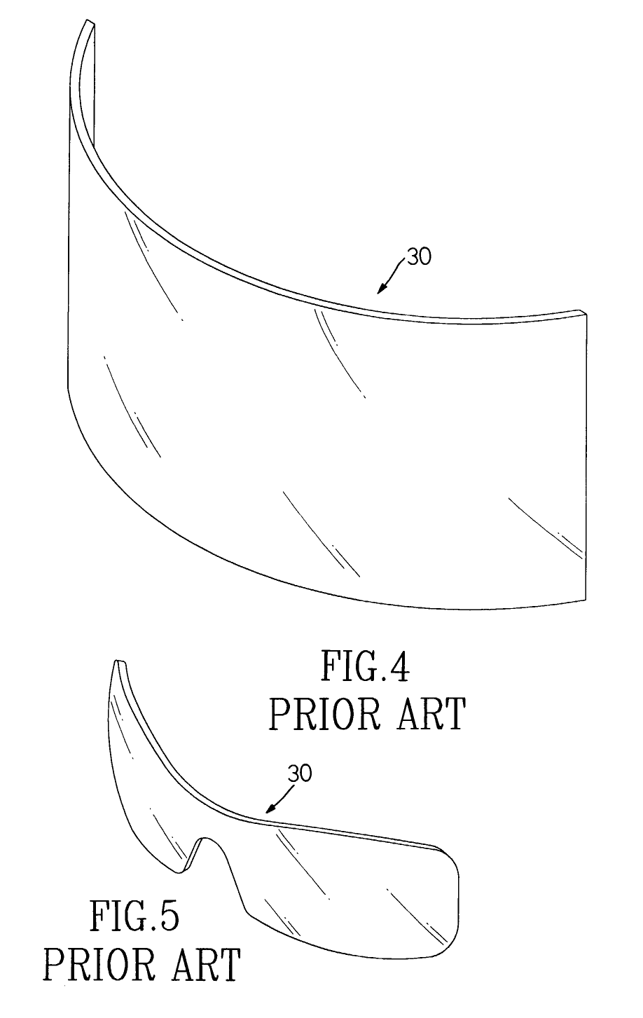

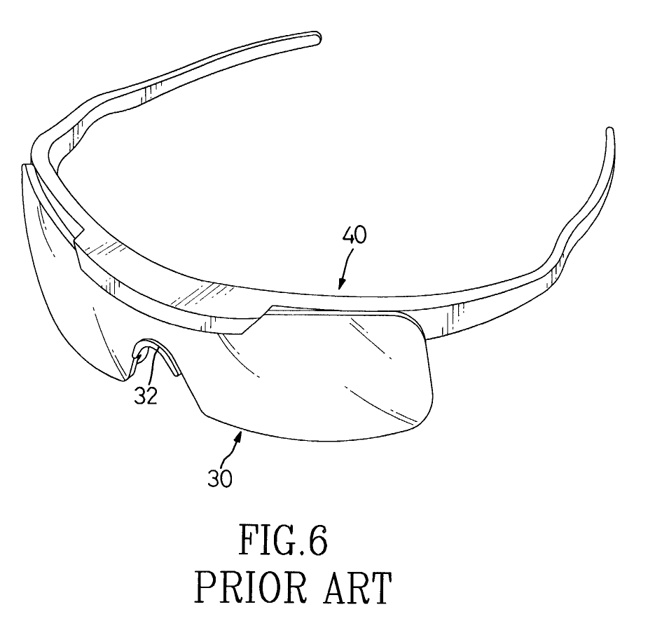

With reference to FIGS. 2 and 3, the lens portions (10,12) are formed in or are cut to a desired shape, and the bottom of the bridge (14) is cut away to integrally form a nose pad. Accordingly, the integrally formed pair of lenses is formed into a shape for combining with a spectacle frame to achieve a pair of glasses.

Because the lens portions (10, 12) of the integrally formed pair of lenses are located on two sides of the bridge (14) with a radius of curvature different from that of the lens portions (10, 12), the appearance of the pair of glasses with the integrally formed pair of lenses is versatile. In addition, the bridge (14) is formed into a nose pad without any additional processes being necessary so manufacturing the sunglasses or the sport glasses is convenient and the cost for manufacturing them is reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An integrally formed pair of lens for a pair of glasses comprising:
a curved body having a middle portion and at least two radii of curvature; and
a curved bridge formed on the middle portion of the body to divide the body into two lens portions,
wherein the bridge has a radius of curvature different from that of the lens portions; and
the radius of curvature of the lens portions is the same.
